(19) United States
(12) Patent Application Publication
(10) Pub. No.: US 2025/0349931 A1
(43) Pub. Date: Nov. 13, 2025

(54) BATTERY ASSEMBLY

(71) Applicant: SK On Co., Ltd., Seoul (KR)

(72) Inventors: Se Hyeon KIM, Daejeon (KR); Do Yun KWAK, Daejeon (KR); Ji Min KIM, Daejeon (KR); Suk Ho SHIN, Daejeon (KR); Seok Hwan LEE, Daejeon (KR)

(21) Appl. No.: 19/176,824

(22) Filed: Apr. 11, 2025

(30) Foreign Application Priority Data
May 9, 2024 (KR) 10-2024-0061133

(51) Int. Cl. H01M 10/6557; H01M 10/613; H01M 10/647; H01M 10/651; H01M 10/6567; H01M 50/264; H01M 50/289

(52) U.S. Cl. CPC H01M 10/6557; H01M 10/647; H01M 10/651; H01M 10/6567; H01M 50/264; H01M 50/289; H01M 10/613

(57) ABSTRACT

A battery assembly includes a plurality of battery cells stacked in a preset stacking direction, a receiving housing receiving the plurality of battery cells, a cell receiving space receiving the plurality of battery cells in the receiving housing, a supporting portion forming a flow path separated from the cell receiving space at a lower portion of the cell receiving space, a fixing portion arranged on one surface of opposite surfaces of the supporting portion which faces the cell receiving space and fixing the plurality of battery cells to the supporting portion, a cooling portion including a plate-shaped first pad positioned between the plurality of battery cells in the stacking direction, and an immersion material in contact with the plurality of battery cells in the cell receiving space and passing through the flow path.

### CROSS-REFERENCE TO RELATED PATENT APPLICATION

The present application claims priority under 35 U.S.C. § 119(a) to Korean patent application number 10-2024-0061133, filed on May 9, 2024, in the Korean Intellectual Property Office, the entire disclosure of which is incorporated herein by reference.

### BACKGROUND OF THE INVENTION

### 1. Field

Various embodiments of the present disclosure generally relate to a battery assembly.

### 2. Description of the Related Art

Secondary batteries are batteries that convert electrical energy into chemical energy and store the chemical energy such that the batteries can be reused multiple times through charging and discharging. Secondary batteries are widely used throughout the industry due to their economical and eco-friendly characteristics. In particular, lithium secondary batteries, among the secondary batteries, are widely used in the entire industry, for example, in portable devices that require high-density energy.

The operating principle of lithium secondary batteries is the electrochemical oxidation-reduction reaction. In other words, it is the principle that electricity is generated by the movement of lithium ions and is charged in the opposite process. In lithium secondary batteries, the phenomenon in which lithium ions from the anode escape and move to the cathode through the electrolyte and the separator is called discharging. The opposite process of the phenomenon is called charging.

In the process of repeatedly charging and discharging secondary batteries, a large amount of heat can be generated. A large amount of heat can degrade the performance of the secondary batteries and, in some cases, can cause a fire or an explosion. Therefore, research on technologies that efficiently cool and discharge heat generated from secondary batteries is being actively conducted.

### SUMMARY OF THE INVENTION

According to one aspect of embodiments of the present disclosure, the performance of a battery assembly is improved by improving the cooling efficiency of a battery cell.

According to another aspect of embodiments of the present disclosure, the stability of a battery assembly is improved by minimizing or reducing the position change of a battery cell in a receiving housing.

Various embodiments of the present disclosure can be widely applied in the green technology fields such as electric vehicles, battery charging stations, and other technologies using batteries such as photovoltaics and wind power. Furthermore, various embodiments of the present disclosure can be used in eco-friendly electric vehicles, hybrid vehicles, and the like to suppress or reduce air pollution and greenhouse gas emissions to prevent or mitigate climate change.

A battery assembly according to embodiments of the present disclosure includes a plurality of battery cells stacked in a preset stacking direction, a receiving housing receiving the plurality of battery cells, a cell receiving space receiving the plurality of battery cells in the receiving housing, a supporting portion forming a flow path separated from the cell receiving space at a lower portion of the cell receiving space, a fixing portion arranged on one surface of opposite surfaces of the supporting portion which faces the cell receiving space and fixing the plurality of battery cells to the supporting portion, a cooling portion including a plate-shaped first pad positioned between the plurality of battery cells in the stacking direction, and an immersion material in contact with the plurality of battery cells in the cell receiving space and passing through the flow path.

According to an embodiment, the flow path may extend parallel to a protruding direction of a tab portion formed on one side of each of the plurality of battery cells.

According to an embodiment, the flow path may penetrate the supporting portion.

According to an embodiment, one end of the flow path and another end of the flow path may be formed in opposite directions with respect to a protruding direction of a tab portion formed on one side of each of the plurality of battery cells.

According to an embodiment, the flow path may communicate with the cell receiving space.

According to an embodiment, the supporting portion may include partitions spaced apart in the stacking direction.

According to an embodiment, the partitions may extend in a direction in which the flow path extends.

According to an embodiment, each of the partitions may be formed at a corresponding position between two adjacent battery cells among the plurality of battery cells.

According to an embodiment, the cooling portion may include a second pad formed by bending one end of the first pad which faces upward. The second pad may cover at least a portion of an upper surface of a battery cell in contact with the first pad.

According to an embodiment, the second pad may be in contact with the receiving housing.

According to an embodiment, a length of each of the plurality of battery cells in a height direction of the receiving housing may be less than or equal to a length of the first pad.

According to an embodiment, the cooling portion may be fixed to the supporting portion.

According to an embodiment, one surface of the cooling portion may be in contact with one battery cell of the plurality of battery cells, and another surface of the cooling portion may be in contact with another battery cell adjacent to the one battery cell.

According to an embodiment, the receiving housing may be provided with a through hole formed by penetrating one surface of the receiving housing.

According to an embodiment, the immersion material may include an insulating material.

According to an embodiment, thermal conductivity of the fixing portion may be 3 W/m·K or less.

According to some embodiments of the present disclosure, the performance of a battery assembly may be improved by improving the cooling efficiency of a battery cell.

According to some embodiments of the present disclosure, the stability of a battery assembly may be improved by minimizing or reducing the position change of a battery cell in a receiving housing.

### BRIEF DESCRIPTION OF THE DRAWINGS

FIG. 1 is a diagram illustrating a battery cell according to an embodiment of the present disclosure;

FIG. 2 is a diagram illustrating a battery assembly according to an embodiment of the present disclosure;

FIG. 3 is an exploded view of a battery assembly according to another embodiment of the present disclosure;

FIGS. 4 and 5 are cross-sectional views of a battery assembly according to another embodiment of the present disclosure;

FIG. 6 is an enlarged view of area C of FIG. 5; and

FIGS. 7 and 8 are cross-sectional views of a battery assembly according to another embodiment of the present disclosure.

### DETAILED DESCRIPTION

Hereinafter, specific descriptions of the present disclosure are provided with reference to the accompanying drawings. It is noted, however, that the descriptions are merely illustrative and the present disclosure is not limited to specific embodiments described in this specification.

Specific terms in this specification are merely used for convenience of illustration, and are not used to limit embodiments provided herein.

For example, expressions such as “sameness” and “same” indicate not only a state of being strictly the same, but also a state in which there is a tolerance or a difference to the extent that the same function is obtained.

For example, expressions indicating relative or absolute arrangement such as “in a direction,” “along a direction,” “parallel,” “vertically,” “centrally,” “concentrically,” or “coaxially” not only strictly indicate such arrangement, but also indicate a state of relative displacement with a tolerance or an angle or distance to the extent that the same function is obtained.

To explain the present disclosure, a spatial orthogonal coordinate system based on an X axis, a Y axis, and a Z axis orthogonal to each other will be described below. Each axial direction (an X-axis direction, a Y-axis direction, and a Z-axis direction) means both directions in which each axis extends.

An X direction, a Y direction, and a Z direction mentioned below are intended to explain the present disclosure such that the present disclosure can be clearly understood, and it goes without saying that each direction may be defined differently depending on where the standard is placed.

Hereinafter, the use of terms such as “first,” “second,” and “third” before the components mentioned below is merely intended to avoid confusion of the components to be referred to, and is not intended to indicate any order, importance, or master-slave relationship between the components. For example, an invention may include only the second component without the first component.

The terms used in this disclosure are for the purpose of describing specific embodiments and are not intended to limit the scope of the claims. As used in the descriptions of embodiments and the appended claims, singular forms in the present disclosure are intended to include plural forms as well, unless the context clearly indicates otherwise.

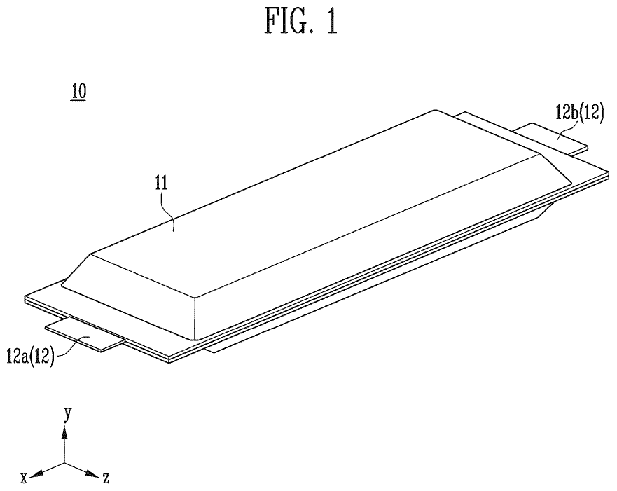

FIG. 1 is a diagram illustrating a battery cell 10 according to an embodiment of the present disclosure.

A battery assembly 100 of the present disclosure includes a plurality of battery cells 10 stacked in a preset stacking direction, a receiving housing 110 receiving the plurality of battery cells 10, a cell receiving space 150, in the receiving housing 110, receiving the plurality of battery cells 10, a supporting portion 200 forming a flow path 210 separated from the cell receiving space 150 at a lower portion of the cell receiving space 150, a fixing portion 300 arranged on one surface, which faces the cell receiving space 150, of opposite surfaces of the supporting portion 200 and fixing the plurality of battery cells 10 to the supporting portion 200, a cooling portion 600 including a plate-shaped first pad 610 positioned between the plurality of battery cells 10 in the stacking direction, and an immersion material 700 in contact with the plurality of battery cells 10 in the cell receiving space 150 and passing through the flow path 210.

The battery cell 10 of the present disclosure may be a secondary battery that can be repeatedly used by charging and discharging electrical energy. For example, the battery cell 10 of the present disclosure may refer to a lithium secondary battery or a lithium ion battery, but is not limited thereto. As another example, the battery cell 10 of the present disclosure may refer to an all-solid-state battery.

The battery cell 10 may be classified into a pouch-type secondary battery, a prismatic secondary battery, or a cylindrical secondary battery depending on a shape. Referring to FIG. 1, for convenience of description, a pouch-type secondary battery is shown as an example in this specification, but embodiments of the present disclosure are not limited thereto.

The battery cell 10 may include an electrode assembly. The electrode assembly may include a cathode and an anode. The electrode assembly can convert chemical energy into electrical energy through redox reactions of the cathode and the anode.

The battery cell 10 may further include a separator. The separator can be located between the cathode and the anode to block contact between the cathode and the anode. The type of separator is not particularly limited, but may include a porous polymer film. For example, the separator may include a porous polymer film or a porous nonwoven.

The battery cell 10 may further include an electrolyte. The electrolyte may be a medium that transfers ions or a current between the cathode and the anode. The electrolyte may be a non-aqueous electrolyte solution. The electrolyte solution may include a lithium salt and an organic solvent.

The battery cell 10 may further include a case 11 receiving the electrode assembly therein. The case 11 may include an outer insulating layer and an inner adhesive layer including a polymer material, and a metal layer interposed between the outer insulating layer and the inner adhesive layer. The case 11 may include a material having high mechanical rigidity to protect the battery cell 10 from external impact. For example, the case 11 may include an aluminum layer.

The battery cell 10 may further include a tab portion 12 protruding to the outside of the case 11 for electrical connection with the outside. The tab portion 12 may protrude in the X-axis direction. In this specification, the protruding direction of the tab portion 12 may mean a direction parallel to the X-axis direction.

The tab portion 12 may be connected to the cathode and the anode of the battery cell 10. The tab portion 12 may include a cathode tab 12a connected to the cathode and an anode tab 12b connected to the anode. In an embodiment, one end of the cathode tab 12a may be in contact with the cathode, and the other end thereof may protrude to the outside of the case 11. In addition, one end of the anode tab 12b may be in contact with the anode, and the other end thereof may protrude to the outside of the case 11.

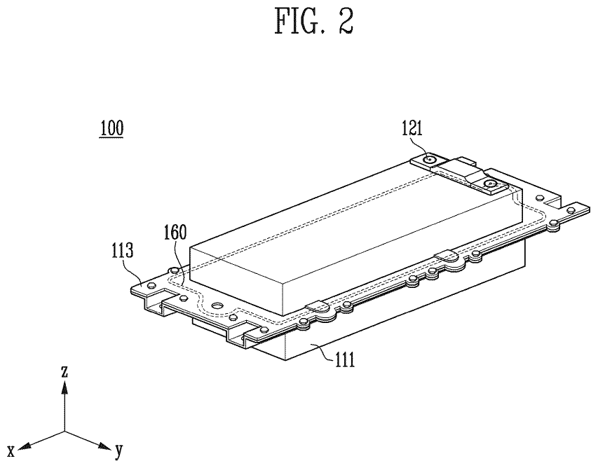

FIG. 2 is a diagram illustrating the battery assembly 100 according to an embodiment of the present disclosure.

Referring to FIG. 2, the battery assembly 100 of the present disclosure includes the receiving housing 110 receiving the plurality of battery cells 10. The plurality of battery cells 10 may be located in the receiving housing 110. The receiving housing 110 may be in various shapes. The shape of the receiving housing 110 is not particularly limited as long as the plurality of battery cells 10 are located therein and the plurality of battery cells 10 can be protected from external impact.

The battery assembly 100 of the present disclosure further includes the cell receiving space 150 receiving the plurality of battery cells 10 in the receiving housing 110. The cell receiving space 150 may be formed in the receiving housing 110. That is, the plurality of battery cells 10 may be located in the cell receiving space 150 in the receiving housing 110.

At least a part of the cell receiving space 150 may be formed by the receiving housing 110. As a result, when the shape of the receiving housing 110 changes, the shape of the cell receiving space 150 may also change.

The battery assembly 100 of the present disclosure includes the immersion material 700 in contact with the plurality of battery cells 10 in the cell receiving space 150. The immersion material 700 may be located within the receiving housing 110. The immersion material 700 may be located in the receiving housing 110 to immerse the plurality of battery cells 10 therein. That is, when the immersion material 700 is received in the receiving housing 110, one or more of the plurality of battery cells 10 may be submerged by the immersion material 700.

The amount of the immersion material 700 located in the receiving housing 110 is not particularly limited. In an embodiment, the inside of the receiving housing 110 may be filled with the immersion material 700. In another embodiment, the immersion material 700 may be provided to fill a preset depth in the height direction of the receiving housing 110.

The immersion material 700 may include an insulating material. The immersion material 700 may not be electrically connected even when the immersion material 700 comes into contact with one or more of the plurality of battery cells 10. For example, the immersion material 700 may be, but is not limited to, an insulating oil.

The immersion material 700 may be injected from the outside of the receiving housing 110 into the receiving housing 110 and may be discharged from the inside of the receiving housing 110 to the outside of the receiving housing 110. In an embodiment, the immersion material 700 moves along a preset path, but the receiving housing 110 may be provided in the middle of a circulation path. That is, the immersion material 700 may continue to move without being stuck in the receiving housing 110.

In another embodiment, the immersion material 700 might not be discharged after being injected into the receiving housing 110. Unlike the above-mentioned case, the immersion material 700 does not move along the circulation path, and may be received in the receiving housing 110 to cool the plurality of battery cells 10.

The receiving housing 110 may be further provided a through hole 120 formed by penetrating one surface of the receiving housing 110. The through hole 120 may be formed by penetrating one surface of the receiving housing 110. The immersion material 700 may be injected from the outside to the inside of the receiving housing 110 through the through hole 120. In addition, the immersion material 700 may be discharged from the inside of the receiving housing 110 to the outside of the receiving housing 110 through the through hole 120.

The through hole 120 may be connected to one end of an injection tube (not shown) for injecting the immersion material 700, and may be connected to one end of a discharge tube (not shown) for discharging the immersion material 700. The immersion material 700 can thus be injected into or discharged from the receiving housing 110.

After the immersion material 700 is injected into the receiving housing 110, the through hole 120 may be closed. Accordingly, the movement of the immersion material 700 may be blocked, thereby preventing or mitigating the immersion material 700 from being unintentionally discharged even when the position of the battery assembly 100 changes or there is external impact.

In an embodiment, the battery assembly 100 of the present disclosure may further include a hole plug 121. The hole plug 121 may be provided in a shape corresponding to the through hole 120. By closing the through hole 120 with the hole plug 121, the movement of the immersion material 700 through the through hole 120 can be minimized, reduced, or blocked.

The through hole 120 may include one or more through holes 120. For example, referring to FIG. 2, two through holes 120 may be provided, so that the immersion material 700 may be injected through one through hole 120 and the immersion material 700 may be discharged through the other through hole 120. However, embodiments of the present disclosure are not limited thereto, and the through hole 120 may be provided as one through hole 120, so that the immersion material 700 may be injected into and discharged from the one through hole 120.

The receiving housing 110 may include a receiving body 111 and a receiving cover 113. The receiving body 111 may support the plurality of battery cells 10. The receiving cover 113 may be coupled to the receiving body 111 to cover the plurality of battery cells 10. The receiving body 111 and the receiving cover 113 may be detachably coupled.

Referring to FIG. 2, the receiving housing 110 may include flanges. A body flange may be formed on an outer side of the receiving body 111, and a cover flange may be formed on an outer side of the receiving cover 113. By bringing the body flange and the cover flange into contact with each other, the coupling force between the receiving body 111 and the receiving cover 113 can be improved.

As described above, because the immersion material 700 may be located in the receiving housing 110, there is a possibility that the immersion material 700 moves through a gap between the receiving body 111 and the receiving cover 113 when the receiving body 111 and the receiving cover 113 are coupled. In order to prevent or mitigate the immersion material 700 from moving through the gap, the receiving body 111 and the receiving cover 113 need to be closely coupled as much as possible, and the flanges can strengthen the adhesion and minimize or reduce the leakage of the immersion material 700.

In an embodiment, a sealing member 160 may be provided in the gap between the receiving body 111 and the receiving cover 113. The sealing member 160 may be provided along corners of the receiving body 111 and the receiving cover 113 to minimize or reduce the movement of the immersion material 700 through the gap.

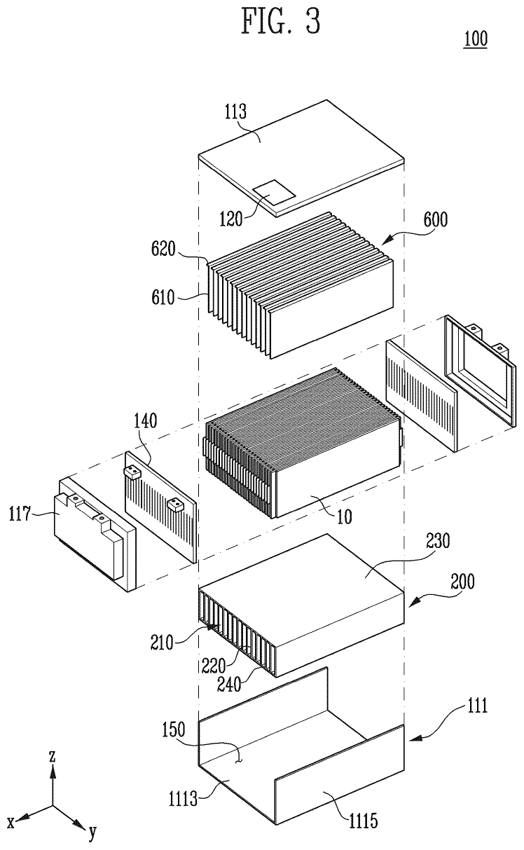

FIG. 3 is an exploded view of the battery assembly 100 according to another embodiment of the present disclosure.

Referring to FIG. 3, the receiving body 111 may include a body bottom surface 1113 and a body side surface 1115. The plurality of battery cells 10 may be located on the body bottom surface 1113. The body side surface 1115 may extend at each of opposite corners of the body bottom surface 1113 along a direction in which the plurality of battery cells 10 are located. The cell receiving space 150 may be formed by the body bottom surface 1113 and the body side surface 1115.

The receiving cover 113 may be coupled to the receiving body 111. For example, the receiving cover 113 may be coupled with the body side surface 1115. The receiving cover 113 and the body side surface 1115 may be screwed by an engaging member or welded, but the coupling method is not particularly limited.

The plurality of battery cells 10 may be stacked in a preset stacking direction. Referring to FIG. 3, the plurality of battery cells 10 may be stacked in the Y-axis direction. The plurality of battery cells 10 may be sequentially stacked on the body bottom surface 1113 in the Y-axis direction. In this specification, the stacking direction of the plurality of battery cells 10 may mean a direction parallel to the Y-axis direction.

The battery assembly 100 of the present disclosure may further include a bus bar assembly 140. The bus bar assembly 140 may electrically connect at least a part of the plurality of battery cells 10. The bus bar assembly 140 may be located in the receiving housing 110. The bus bar assembly 140 may be located to face the tab portion 12 of each of the plurality of battery cells 10 in a direction in which each tab portion 12 is positioned. Referring to FIG. 3, the bus bar assembly 140 may be located outside the plurality of battery cells 10 in the X-axis direction.

In an embodiment, the bus bar assembly 140 may include a slit formed by penetrating one surface thereof, and the tab portion 12 of each of the plurality of battery cells 10 may be inserted into the slit. As a result, the plurality of battery cells 10 and the bus bar assembly 140 may be electrically connected.

The battery assembly 100 of the present disclosure may further include an end cover 117. The end cover 117 may be coupled to the receiving housing 110 to protect the battery assembly 100. The end cover 117 may form one surface of the cell receiving space 150.

The battery assembly 100 of the present disclosure further includes the cooling portion 600. The cooling portion 600 may be positioned between the plurality of battery cells 10 in the stacking direction. The cooling portion 600 may include the plate-shaped first pad 610.

The cooling portion 600 may be positioned between the plurality of battery cells 10 to cool the plurality of battery cells 10. In the stacking direction of the plurality of battery cells 10, the cooling portion 600 and the plurality of battery cells 10 may be stacked alternately with each other in a preset number.

In an embodiment, one cooling portion 600 and one battery cell 10 may be stacked alternately with each other. Alternatively, in another embodiment, one cooling portion 600 and two battery cells 10 may be stacked alternately with each other, but the present disclosure is not limited thereto.

The first pad 610 may be in a plate shape. As a result, the cooling efficiency can be improved by maximizing or increasing the contact area between the cooling portion 600 and the plurality of battery cells 10. The first pad 610 may be in contact with the case 11 of the battery cell 10.

Referring back to FIG. 1, the battery cell 10 may include a flat surface facing a direction perpendicular to the protruding direction of the tab portion 12. The first pad 610 may be in contact with the flat surface.

The thickness of the first pad 610 may be less than or equal to the thickness of the battery cell 10. The length of the first pad 610 in the stacking direction may be less than or equal to the length of the battery cell 10. In order for the cooling portion 600 to cool the battery cell 10, the heat transfer efficiency of the cooling portion 600 needs to be improved, and accordingly, it may be preferable that the cooling portion 600 has a small thickness. The cooling portion 600 may further include a second pad 620, which will be described in detail below.

The battery assembly 100 of the present disclosure includes the supporting portion 200 that forms the flow path 210 separated from the cell receiving space 150 at the lower portion of the cell receiving space 150. The supporting portion 200 may be located in the receiving housing 110, but may be located at the lower portion of the cell receiving space 150. As a result, the plurality of battery cells 10 may be positioned over the supporting portion 200.

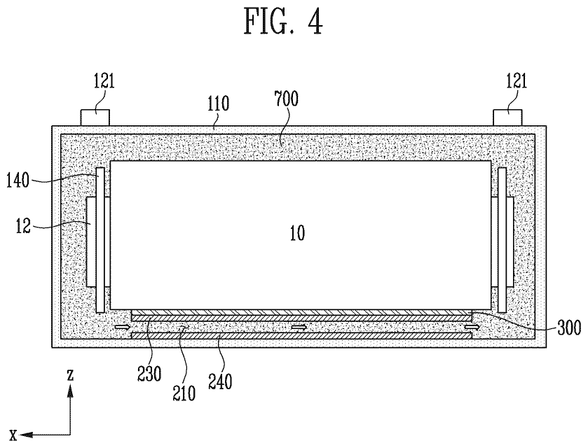

The supporting portion 200 may form the flow path 210. The flow path 210 may be separated from the cell receiving space 150. In other words, the inside of the receiving housing 110 may be separated into the cell receiving space 150 and the flow path 210 by the supporting portion 200. The fact that the flow path 210 is separated from the cell receiving space 150 does not mean that the movement of the immersion material 700 is blocked between the flow path 210 and the cell receiving space 150. This will be described below with reference to FIGS. 4 to 7.

Referring to FIG. 3, the supporting portion 200 may include a first plate 230 and a second plate 240. The flow path 210 may be formed between the first plate 230 and the second plate 240. That is, the first plate 230 and the second plate 240 may be spaced apart from each other. The first plate 230 and the second plate 240 may be formed in parallel.

The first plate 230 and the second plate 240 are spaced apart from each other in the height direction of the receiving housing 110, so that the flow path 210 may be formed under the plurality of battery cells 10, and the immersion material 700 may move through the flow path 210.

The first plate 230 and the second plate 240 may have the same shape. The first plate 230 may be located closer to the plurality of battery cells 10 than the second plate 240. The plurality of battery cells 10 may be located over the first plate 230, and the second plate 240 may be in contact with the receiving housing 110.

The first plate 230 and the second plate 240 may include the same material as the first pad 610. The first pad 610 may include a material having high thermal conductivity, and the first plate 230 and the second plate 240 may also include materials having high thermal conductivity. This allows efficient heat exchange between the immersion material 700 and the battery cell 10.

The supporting portion 200 may further include a partition 220. The partition 220 may be formed between the first plate 230 and the second plate 240. One end of the partition 220 may contact the first plate 230 and another end of the partition 220 may contact the second plate 240.

The partition 220 may include a plurality of partitions 220. One of the plurality of partitions 220 may connect one corner of the first plate 230 and one corner of the second plate 240 to each other. In addition, the partition 220 may connect another corner of the first plate 230 which is located opposite to the one corner of the first plate 230 and another corner of the second plate 240 which is located opposite to the one corner of the second plate 240. Consequently, the flow path 210 may be formed by the first plate 230, the second plate 240, and the partition 220. As the number of partitions 220 increases, the number of flow paths 210 may also increase.

The battery assembly 100 of the present disclosure includes the fixing portion 300. The fixing portion 300 may be arranged on one surface of opposite surfaces of the supporting portion 200 which faces the cell receiving space 150, and may fix the plurality of battery cells 10 to the supporting portion 200.

In an embodiment, the fixing portion 300 may be applied to and located on the supporting portion 200. The fixing portion 300 may be applied to the first plate 230 of the supporting portion 200. The plurality of battery cells 10 may be positioned and fixed on the applied fixing portion 300.

The fixing portion 300 may include a material having high thermal conductivity. This is to prevent or mitigating heat exchange between the supporting portion 200 and the battery cell 10 from being blocked by the fixing portion 300. The thermal conductivity of the fixing portion 300 may be 3 W/m·K or less. For example, the fixing portion 300 may be a thermal adhesive. The fixing portion 300 may be, but is not limited to, a conductive silicone adhesive or an epoxy adhesive.

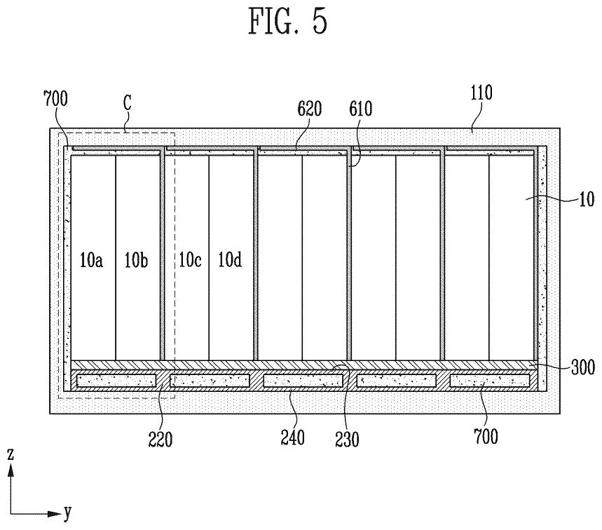

FIGS. 4 and 5 are cross-sectional views of the battery assembly 100 according to another embodiment of the present disclosure. Specifically, FIG. 4 shows a cross section of the battery assembly 100 taken along the direction parallel to the protruding direction of the tab portion 12, and FIG. 5 shows a cross section taken along the direction parallel to the stacking direction.

The flow path 210 may extend in parallel to the protruding direction of the tab portion 12 formed at one side of each of the plurality of battery cells 10. Referring to FIG. 4, the flow path 210 may extend in the X-axis direction. As a result, the battery cell 10 can be efficiently cooled in the protruding direction of the tab portion 12 of each battery cell 10.

The flow path 210 may communicate with the cell receiving space 150. That is, the immersion material 700 located in the cell receiving space 150 may move to the flow path 210. Referring to FIGS. 3 and 4, the immersion material 700 may move from the cell receiving space 150 to the flow path 210 through an opening opened in the X-axis direction between the first plate 230 and the second plate 240.

The flow path 210 may penetrate the supporting portion 200. One end of the flow path 210 and the other end of the flow path 210 may be formed in opposite directions with respect to the protruding direction of the tab portion 12 formed on one side of each of the plurality of battery cells 10. Referring to FIG. 4, based on the X-axis direction, one end of the flow path may be located on the left side, and the other end of the flow path may be located on the right side.

As the flow path 210 penetrates the supporting portion 200, the immersion material 700 may circulate without being fixed in the supporting portion 200 and the supporting portion 200 may be cooled. In addition, referring to FIG. 4, one end of the flow path 210 may be located on the left side in the X-axis direction, and the other end of the flow path 210 may be located at the right side in the X-axis direction.

For convenience of description, it may be assumed that one end of the flow path 210 is an inlet and the other end of the flow path 210 is an outlet. The immersion material 700 may enter through the inlet and exit to the outlet. The temperature of the immersion material 700 located in the flow path 210 may increase through heat exchange with the plurality of battery cells 10, and the temperature will be relatively higher than that of the immersion material 700 located outside the flow path 210.

As a result, the density of the immersion material 700 located in the flow path 210 decreases and thus the immersion material 700 moves upward through the outlet, and the cold immersion material 700 located outside the flow path 210 moves into the flow path 210 through the inlet, so that the immersion material 700 can circulate in the receiving housing 110.

The above-described heat exchange and convection process is only an embodiment for convenience of explanation, and heat exchange and convection may be performed differently from the above-described embodiment.

However, because the flow path 210 of the present disclosure penetrates the supporting portion 200, the immersion material 700 can circulate more efficiently.

Referring to FIG. 5, the supporting portion 200 may be located under the plurality of battery cells 10. The number of the plurality of battery cells 10 may be increased or decreased differently from that shown in FIG. 5.

The supporting portion 200 may include the partitions 220 that are spaced apart in the stacking direction. The plurality of partitions 220 may be provided. As described above, the partitions 220 may be spaced apart to form the flow path 210 between the partitions 220. In addition, the partition 220 may extend in a direction in which the flow path 210 extends. Referring back to FIG. 5, the partitions 220 may be spaced apart in the Y-axis direction, and the flow path 210 may be formed between the partitions 220.

The partition 220 may be formed at a corresponding position between two adjacent battery cells 10 among the plurality of battery cells 10. That is, the partition 220 may be located between two adjacent battery cells 10.

Referring to FIG. 5, the plurality of battery cells 10 may be arranged from the left end toward the right side. From the starting point, the battery cells 10 may be sequentially arranged toward the right, starting with a first battery cell 10a, a second battery cell 10b, a third battery cell 10c, and a fourth battery cell 10d. The partition 220 may be formed at a corresponding position between the second battery cell 10b and the third battery cell 10c.

Of course, the partition 220 may also be formed between the first battery cell 10a and the second battery cell 10b or between the third battery cell 10c and the fourth battery cell 10d.

The cooling portion 600 may include the second pad 620 formed by bending one end of the first pad 610 which faces upward. The second pad 620 may cover at least a portion of an upper surface of the battery cell 10 in contact with the first pad 610.

The first pad 610 may extend in the height direction of the receiving housing 110, one end of the first pad 610 may face the receiving cover 113, and the other end of the first pad 610 may face the receiving body 111. One end of the first pad 610 which faces upward may mean one end of the first pad 610 which faces the receiving cover 113.

The second pad 620 may cover at least a portion of the upper surface of the battery cell 10. That is, one surface of the second pad 620 may face the upper surface of the battery cell 10. The first pad 610 and the second pad 620 may form an acute angle. In an embodiment, the first pad 610 and the second pad 620 may form the vertical.

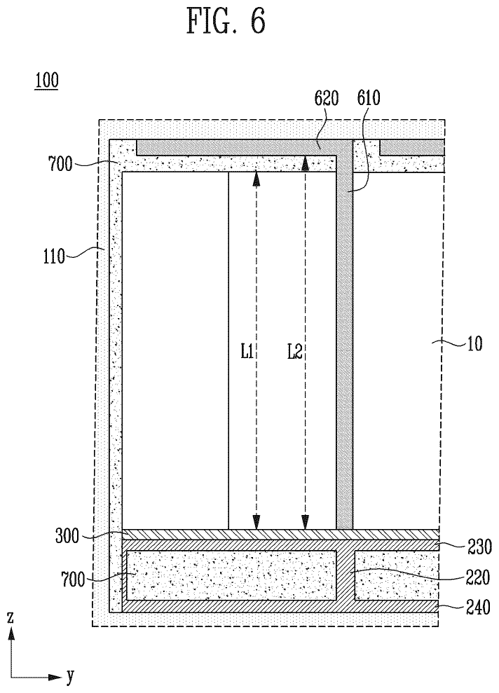

FIG. 6 is an enlarged view of area C of FIG. 5. The configuration of the battery assembly 100 will be described in detail with reference to FIG. 6.

The second pad 620 may be in contact with the receiving housing 110. The second pad 620 may be in contact with the receiving cover 113. Referring to FIG. 6, an upper surface of the cooling portion 600 is pressed by the receiving housing 110, and a lower surface of the cooling portion 600 is pressed by the supporting portion 200, so that the position of the cooling portion 600 can be stably fixed.

The length of each of the plurality of battery cells 10 in the height direction of the receiving housing 110 may be less than or equal to the length of the first pad 610. In this specification, the height direction of the receiving housing 110 may mean the Z-axis direction.

The length of the battery cell 10 is less than or equal to the length of the first pad 610, so that the battery cell 10 may be covered by the first pad 610. In addition, a space in which the second pad 620 is bent may be provided. Referring to FIG. 6, a length L1 of the battery cell 10 may be less than or equal to a length L2 of the first pad 610.

In addition, one surface of the cooling portion 600 may be in contact with one of the plurality of battery cells 10, and another surface of the cooling portion 600 may be in contact with another battery cell 10 adjacent to the one of the plurality of battery cells 10. Referring to FIG. 6, the first pad 610 may be in contact with two adjacent battery cells 10, which can improve cooling efficiency.

The cooling portion 600 may be fixed to the supporting portion 200. The plurality of battery cells 10 may be fixed to the supporting portion 200 by the fixing portion 300. The cooling portion 600 may also be fixed to the supporting portion 200 by the fixing portion 300.

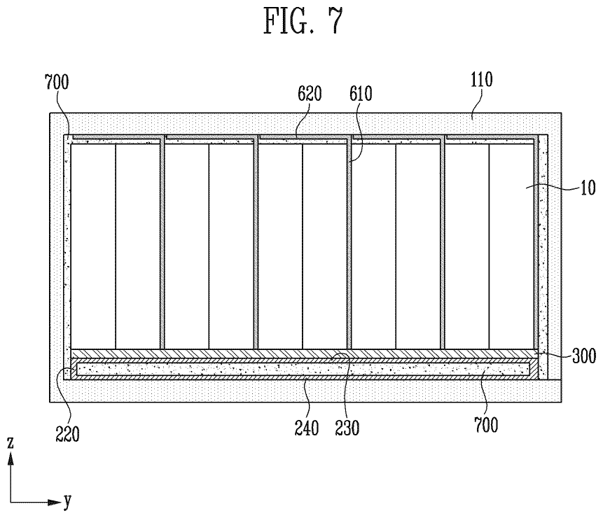

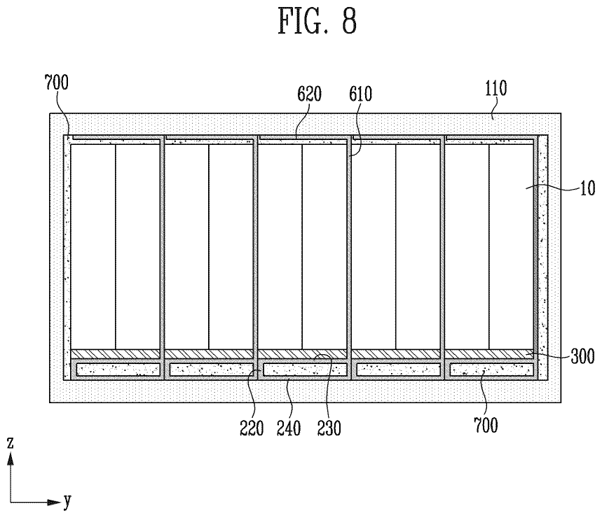

FIGS. 7 and 8 are cross-sectional views of the battery assembly 100 according to another embodiment of the present disclosure.

The battery assembly 100 of the present disclosure may be freely modified within the scope of capable of achieving the object of and the problem to be solved by the present disclosure. FIGS. 7 and 8 illustrate various embodiments of the battery assembly 100 of the present disclosure.

Specifically, FIG. 7 illustrates the battery assembly 100 in which one flow path 210 is formed. The embodiment shown in FIG. 7 is the same as the embodiment as described above except that one flow path 210 is formed. Referring to FIG. 7, one flow path 210 may be formed by the partitions 220 located on the left and right sides with respect to the Y-axis direction, the first plate 230, and the second plate 240.

In addition, FIG. 8 illustrates the battery assembly 100 in which the supporting portion 200 and the cooling portion 600 are integrally formed. Referring to FIG. 8, the cooling portion 600 and the supporting portion 200 may be integrally formed. That is, opposite ends of the plate-shaped cooling portion 600 may be bent to form the supporting portion 200 and the second pad 620, respectively. One end of the cooling portion 600 may be bent three times to form the supporting portion 200 including the flow path 210 therein, and the other end of the cooling portion 600 may be bent to form the second pad 620. Accordingly, there is no need to separately provide a means for fixing the cooling portion 600 to the supporting portion 200.

Because the present disclosure may be implemented in various forms, the scope of the present disclosure is not limited to the above-described embodiments. The descriptions as set forth above are merely examples applying the principles of the present disclosure, and other configurations may be further included without departing from the scope of the present disclosure.

What is claimed is:

1. A battery assembly, comprising:
a plurality of battery cells stacked in a preset stacking direction;
a receiving housing receiving the plurality of battery cells;
a cell receiving space receiving the plurality of battery cells in the receiving housing;
a supporting portion forming a flow path separated from the cell receiving space at a lower portion of the cell receiving space;
a fixing portion arranged on one surface of opposite surfaces of the supporting portion which faces the cell receiving space and fixing the plurality of battery cells to the supporting portion;
a cooling portion including a plate-shaped first pad positioned between the plurality of battery cells in the stacking direction; and
an immersion material in contact with the plurality of battery cells in the cell receiving space and passing through the flow path.

2. The battery assembly of claim 1, wherein the flow path extends parallel to a protruding direction of a tab portion formed on one side of each of the plurality of battery cells.

3. The battery assembly of claim 1, wherein the flow path penetrates the supporting portion.

4. The battery assembly of claim 3, wherein one end of the flow path and another end of the flow path are formed in opposite directions with respect to a protruding direction of a tab portion formed on one side of each of the plurality of battery cells.

5. The battery assembly of claim 1, wherein the flow path communicates with the cell receiving space.

6. The battery assembly of claim 1, wherein the supporting portion includes partitions spaced apart in the stacking direction.

7. The battery assembly of claim 6, wherein the partitions extend in a direction in which the flow path extends.

8. The battery assembly of claim 7, wherein each of the partitions is formed at a corresponding position between two adjacent battery cells among the plurality of battery cells.

9. The battery assembly of claim 1, wherein the cooling portion includes a second pad formed by bending one end of the first pad which faces upward, and
wherein the second pad covers at least a portion of an upper surface of a battery cell in contact with the first pad.

10. The battery assembly of claim 9, wherein the second pad is in contact with the receiving housing.

11. The battery assembly of claim 1, wherein a length of each of the plurality of battery cells in a height direction of the receiving housing is less than or equal to a length of the first pad.

12. The battery assembly of claim 1, wherein the cooling portion is fixed to the supporting portion.

13. The battery assembly of claim 1, wherein one surface of the cooling portion is in contact with one battery cell of the plurality of battery cells, and another surface of the cooling portion is in contact with another battery cell adjacent to the one battery cell.

14. The battery assembly of claim 1, wherein the receiving housing is provided with a through hole formed by penetrating one surface of the receiving housing.

15. The battery assembly of claim 1, wherein the immersion material includes an insulating material.

16. The battery assembly of claim 1, wherein thermal conductivity of the fixing portion is 3 W/m·K or less.
